(19) United States
(12) Patent Application Publication
(10) Pub. No.: US 2007/0277570 A1
(43) Pub. Date: Dec. 6, 2007

(54) Theftproof Lock For Bicycle

(76) Inventor: Qunmou Yu, Jiangsu Province (CN)

Correspondence Address: VENABLE LLP, P.O. BOX 34385, WASHINGTON, DC, 20043-9998, US

(21) Appl. No.: 11/791,171

(22) PCT Filed: Nov. 7, 2005
(86) PCT No.: PCT/CN05/01865

§ 371 Date: May 21, 2007

(30) Foreign Application Priority Data
Nov. 19, 2004 (CN) 200420108996.X

(51) Int. Cl. B62H 5/00

(52) U.S. Cl. 70/233

(57) ABSTRACT

A theftproof lock, comprising a movable loop 9 mounted on the turning member of the bicycle, a fixed loop 3 mounted on the frame 1, a sheath 11 mounted on the said fixed loop 3, lock rod 12 situated inside the said sheath 11. Said movable loop 9 provides several slots 10, lock tongue inserted in one said slot 10. Said fixed loop 3 mounted on the frame 1 below the upper steel bowl 4, and the upper steel bowl 4 suppressed over the upper section of the fixed loop 3. When the fixed loop and the movable loop are locked together, none of the lock, the fixed loop, and the movable loop can be removed. User can install the lock after buying the bicycle; the lock is suitable to all kinds of bicycle.

The invention relates to a theftproof lock used on a bicycle.

In the prior art, a bicycle lock was always mounted on the back wheel, so that the wheel cannot rotate about the frame to lock the bicycle. The prior lock should be mounted on the frame by screw, so it is easy to be removed. Another configuration is a soft chain lock, which is easy to be snipped, and inconvenient to be put in and out of the wheel during using.

For the moment, there is a kind of theftproof lock used to lock the front part of the bicycle, which can only be turned around in the origin place when locked. Although this mechanism has excellent theftproof performance, a fixed loop must be attached to a fixed member on a frame of a bicycle, causing more working procedures during manufacturing the bicycle, and even no more choice for the customer.

The aim of the present invention is to provide a kind of theftproof lock for locking front wheel which can be installed separately.

The technique scheme of this invention is to provide a certain theftproof lock, comprising:

A moveable loop, which should be immovably mounted on the turning member of the bicycle and provided with many slots extended along a radial direction of the moveable loop;

A fixed loop, being supposed to be immovably mounted on the upper portion of the frame of the bicycle under an upper steel bowl which suppresses on the upper end of the fixed loop;

A sheath which is immovably mounted on the said fixed loop;

A lock-rod which is situated in the inside room of the said sheath; and

A lock-tongue being controlled by the said lock-rod and being inserted in a slot on the movable loop in a locked statement.

Compared with the traditional art, the present invention has such advantages as below:

Due to the fixing location of the said fixed loop, when installing the lock, operators only need disassemble the upper members including the steel bowl, the turning member etc., from a bicycle, assemble the fixed loop to the frame of the bicycle, then relocate the upper members on the frame, and fix the fixed loop to the frame to complete the installation process; and while the fixed loop and the movable loop are locked together, none of the lock, the fixed loop, and the movable loop can be removed; and

Users can install the lock after choosing any kind of bicycle, for the theftproof lock should fit all kinds of bicycle.

The invention and advantages thereof will now be explained in more details with reference to the following drawings:

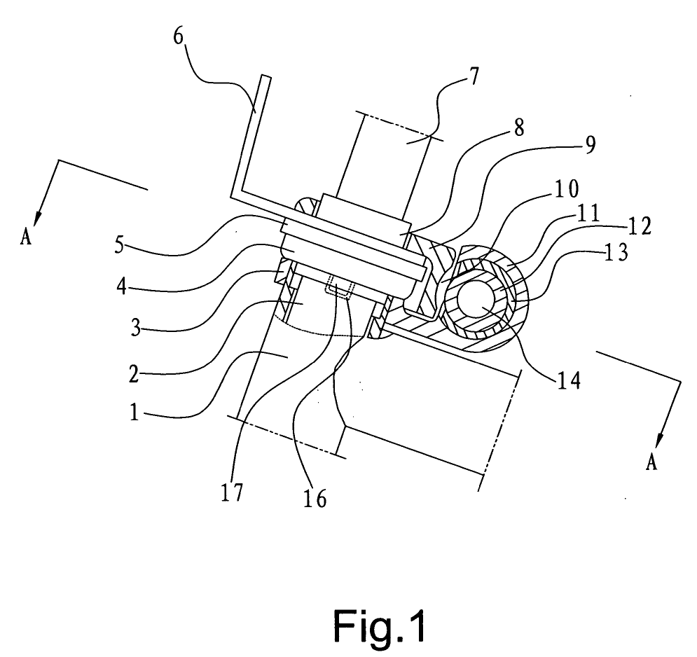

FIG. 1 which shows a schematic view of a first embodiment of the invention when mounted on a bicycle;

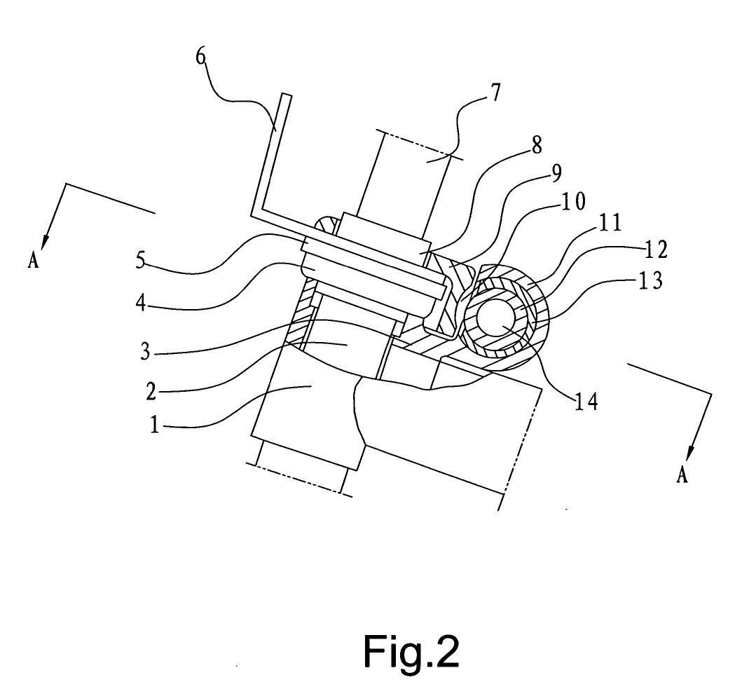

FIG. 2 which shows a schematic view of a second embodiment of the invention when mounted on a bicycle;

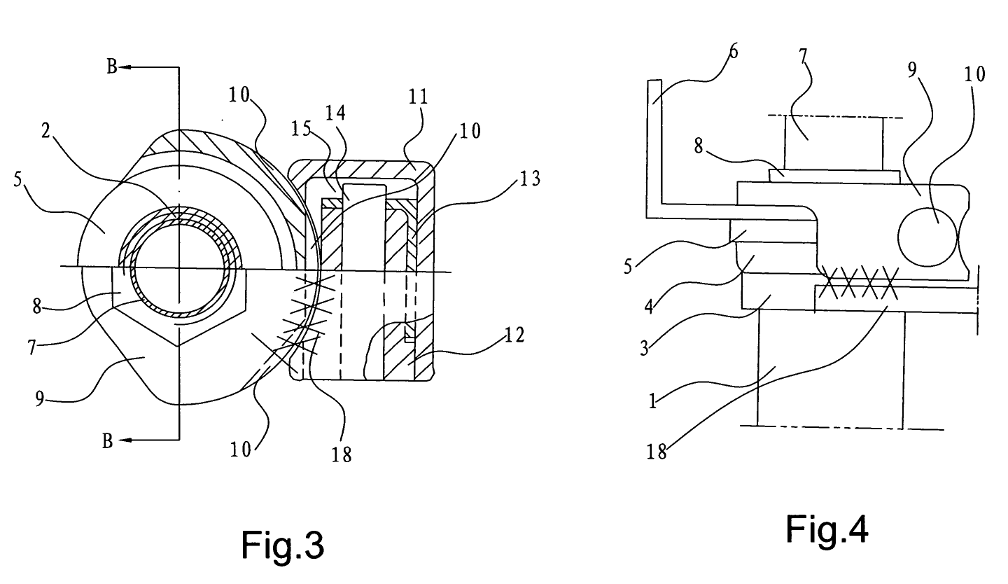

FIG. 3 which shows a cross-sectional view of FIG. 1 and/or FIG. 2 along the line A-A;

FIG. 4 which shows a side view of FIG. 3 in the direction of K;

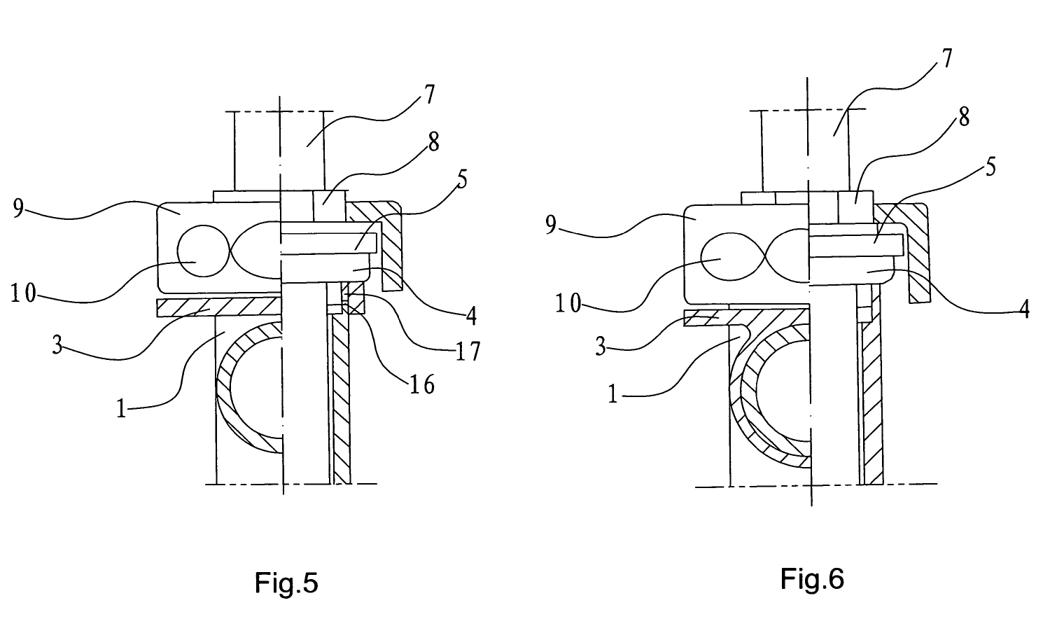

A half cross-sectional view of FIG. 3 along the line B-B corresponding to the first embodiment shown in FIG. 5; and

A half cross-sectional view of FIG. 3 along the line B-B corresponding to the second embodiment shown in FIG. 6; wherein many components are represented by tags including:

(1) a frame; (2) a front-fork veer rod; (3) a fixed loop; (4) an upper steel bowl; (5) a round nut; (6) a light frame; (7) a standing veer tube; (8) a hexagonal nut; (9) a movable loop; (10) a slot; (11) a sheath; (12) a lock-rod; (13) a slipcover; (14) a lock core; (15) a shaft ring; (16) a groove; (17) a protrude tooth; and (18) a marked symbol.

According to all of the above-mentioned drawings, two embodiments of a theftproof lock are shown, the theftproof lock comprising a movable loop 9 which should be mounted on a turning member of a bicycle, a fixed loop 3 which should be mounted on the frame 1 of said bicycle, a sheath 11 being mounted on the said fixed loop 3, a lock-rod 12 situated inside the said sheath 11, and a lock tongue which is carried out as a slip cover 13 controlled by the said lock rod 12. The said movable loop 9 is in shape of a sleeve, the section of the inner wall thereof being hexagonal. The hexagonal inner wall mounted on and fastened to the hexagonal nut 8, to fix the movable loop 9 to the hexagonal nut 8 on the turning member of the bicycle. The said movable loop 9 is provided with several slots 10, for always three slots, along its radial direction, as shown in FIG. 3. The said lock tongue is inserted in one of the said slots 10 while in a locked statement, making fixed loop 3 and the movable loop 9 unable to rotate relatively to each other, namely preventing the turning member from rotating relatively to the bicycle frame, so that the bicycle cannot be normally moved. Said fixed loop 3 is mounted on the frame 1 below an upper steel bowl 4, and also the upper steel bowl 4 suppresses over the upper section of the fixed loop 3.

The said fixed loop 3 and frame 1 according to a first embodiment of the present invention with reference to FIG. 1, are connected removably, said frame 1 processed with a longitudinal groove 16, and the inner brim of said fixed loop 3 mounted with a protrude tooth 17 protuberant along a radial direction, which is inserted in the said groove 16.

With reference to FIG. 2, a second embodiment is also shown, wherein the said fixed loop 3 and the frame 1 are mounted irremovably.

The said movable loop 9 comprises a marked symbol 18, and correspondingly the symbol 18 is also marked at the contact place of the fixed loop 3 and movable loop 9. The said marked symbol 18 as shown in FIG. 3 and FIG. 4, is formed as the license tag of each bicycle, each half of the numbers thereof respectively located on the fixed loop 3 and the movable loop 9.

What is claimed:

1. A theftproof lock for bicycle, comprising
A movable loop 9 which should be immovably mounted on a turning member of a bicycle and provided with many slots extended along a radial direction of the moveable loop;
A fixed loop 3 being supposed to be immovably mounted on an upper portion of a frame 1 of the bicycle;
A sheath 11 immovably mounted on the said fixed loop 3;
A lock-rod 12 situated inside the said sheath 11; and
A lock-tongue being controlled by the said lock-rod and being inserted in a slot on the movable loop in a locked statement; is characterized in that
The said fixed loop 3 should be located on the frame 1 under an upper steel bowl 4 which suppresses on the upper end of the fixed loop 3.

2. The theftproof lock according to claim 1, is characterized in that the said frame 1 is processed a longitudinal groove 16 thereon, and the inner brim of said fixed loop 3 is mounted with a fixed loop protrude tooth 17 protuberant along a radial direction, the protrude tooth 17 being inserted into the said groove 16.

3. The theftproof lock according to claim 1, is characterized in that the said movable loop 9 is irremovably mounted to the said hexagonal nut 8 fixed on the turning member of the bicycle.

4. The theftproof lock according to claim 3, is characterized in that the said movable loop 9 is in shape of a sleeve, the section of the inner wall thereof being hexagonal, wherein the hexagonal inner wall is mounted on and fastened to the hexagonal nut 8.

5. The theftproof lock according to claim 1, is characterized in that the said movable loop 9 is printed with a marked symbol 18 thereon, the said symbol 18 also being marked at the contact place of the fixed loop 3 and movable loop 9.
